(19) United States
(12) Patent Application Publication
(10) Pub. No.: US 2023/0397312 A1
(43) Pub. Date: Dec. 7, 2023

(54) LIGHT ARRANGEMENT

(71) Applicant: Traxon Technologies Ltd., Hong Kong (CN)

(72) Inventors: Joe GASIEWICZ, Commerce, MI (US); John DAVIS, Wilmington, MA (US)

(21) Appl. No.: 18/200,594

(22) Filed: May 23, 2023

Related U.S. Application Data
(60) Provisional application No. 63/348,575, filed on Jun. 3, 2022.

(51) Int. Cl. H05B 45/35; H05B 45/355; H05B 45/18; H05B 45/14; H05B 47/17

(52) U.S. Cl. CPC H05B 45/35; H05B 45/355; H05B 45/18; H05B 45/14; H05B 47/17

(57) ABSTRACT

The invention concerns a lighting arrangement having at least two light strings, each light string comprising at least one optoelectronic component configured for a power consumption in operation of more than 8 W. A couple of adjustable current sources are connected to a respective one of the at least two light strings and configured to provide an adjustable supply current to respective one of the at least two light strings. The arrangement further comprises an AC/DC converter utilizing GaN based FET technology configured to provide a DC supply voltage to the at least two adjustable current sources and the respective light strings connected thereto. Finally, a control circuit is coupled to the at least two adjustable current sources and configured to individually adjust a duty cycle for each of the at least two adjustable current sources and the supply current provided by the at least two adjustable current sources.

### BACKGROUND

Architectural luminaires are often required to provide high output power. However, these requirements often lead to bulky and costly configurations, as they typically include a large number of LEDs and optics to get the desired output power. In addition, a substantial thermal mass is needed to dissipate the large amount of heat generated during operation.

In many lighting applications, luminaire designs implement a dimming control, in which a user can adjust the brightness (or dimming) of the respective LEDs. Such dimming can be implemented by digital method, i.e. adjusting the ON/OFF ratio in a PWM signal driving the LEDs or an analogue method, i.e. adjusting the amplitude of the delivered current to the LEDS. While such approaches are feasible for many applications, the overall power consumption and heat generation remains an issue. In addition, implementation of only analogue dimming control can result in undesired colour shift of the LEDs. Flexibility in implementation options as well as driving such systems is somewhat limited.

There is a need to overcome at least some of the above-mentioned issue and offer a solution that provides a high-power luminaire in a smaller form factor compared to conventional architectures.

### SUMMARY OF THE INVENTION

These and other objects are addressed by the subject matter of the independent claims. Features and further aspects of the proposed principles are outlined in the dependent claims.

This invention takes many different elements and makes them all work together in a single system. The interaction between the different element achieves the desired goal providing a high-power luminaire in a much smaller form factor and in a less costly manner then what is currently done today. For this purpose, the inventors propose utilizing on the one hand high power LEDs, particularly with an overall power of more than 8 W per single optoelectronic device. Such high-power optoelectronic devices enable reducing the overall number of devices thus also reducing the required form factor. However, to realize such advantage, one also requires a high-power supply unit. It has been derived by the inventors that conventional power supplies are often too large in size, such that they become the limiting factor in reducing the overall size of the high-power luminaire device. Consequently, the inventors propose implementing a power supply using GaN based FET components, because such components comprise the necessary electrical characteristic but also a low dissipation allowing for small sizes. In particular, only recently GaN FET became available that can carry the required high current with a reasonably low resistance. Consequently, the site of the heat sink can be significantly reduced. In addition, the switching speed of such GaN based FET is high in the range of a few 10 kHz making it possible also to reduce the size of the switching transformer and filters.

A further aspect relates to the flexibility of operational modes. For a given output power i.e. corresponding to a specified brightness, one may change the ON/OFF ratio for the respective optoelectronic components. The use of high-power optoelectronic components as stated above also offers the possibility to implement a more flexible control scheme, in which the overall brightness is controlled by a combination of current through the devices and the ON/OFF ratio of the control PWM signal. In particular, the proposed setup enables a boost mode, in which additional power (or current) is steered to one or more optoelectronic components without interfering with the dimming functionality by the ON/OFF ratio. Hence, the proposed solution can adjust the colour and brightness independent from each other over a large range, and still be realized in a small form factor. This approach also has the benefit of increasing the operational life of the LEDs used as they may be operated with a lower current and higher ON/OFF ratio or vice versa.

In an aspect the inventors propose a lighting arrangement, comprising at least two light strings, each light string comprising at least one optoelectronic component configured for a power consumption in operation of more than 8 W and in particular at least 10 W. The strings are attached to one or more adjustable current sources, so they can be supplied by a respective current individually. Such attachment is possible by arranging the two strings in parallel with the one or more current sources switchable coupled to them. Alternatively, the two strings can be arranged in a single current path, i.e. in series with the possibility to bypass each optoelectronic component of the two strings.

The one or more adjustable current sources are configured to provide an adjustable supply current to a respective one of the at least two light strings.

Furthermore, the lighting arrangement comprises an AC/DC converter utilizing GaN based FET technology configured to provide a DC supply voltage to the at least two adjustable current sources and the respective light strings connected thereto. Finally, the lighting arrangement comprises a control circuit coupled to the at least two adjustable current sources and configured to individually adjust a duty cycle for each of the at least two adjustable current sources and the supply current provided by the at least two adjustable current sources.

The lighting arrangement in accordance with the proposed principle, offers a significant smaller form factor and fits into fixtures that are about half the volume or less of respective conventional arrangement having the same or a comparable output power. The proposed system design results in higher cd/W and lower costs/W than those conventional designs.

In some further aspects, the lighting arrangement comprises at least four light strings of optoelectronic components, whereby each string is coupled to an adjustable current source. In some aspects, each string comprises components that may be configured to emit light of a certain colour. The optoelectronic components of one particular string can be configured to emit light of the same colour. However, optoelectronic components of different strings may be configured to emit light of different colour. Each string may comprise three LEDs configured for a power consumption in operation of more than 8 W and in particular at least 10 W.

In some aspects, not more than two strings emit light of the same colour. The expression colour in this regard generally refers to one of the main colours, like red, blue, green and white. The optoelectronic components for emission of red, blue, and green light are configured to emit light of a certain colour directly, i.e. without any additional light conversion. Consequently, the material system, on which the optoelectronic components are based upon is usually different. The optoelectronic components configured to emit white light may be configured for light conversion, that is they may include a conversion material to convert a portion of the emitted light. In some instances, the optoelectronic component is configured to emit blue light with a conversion material for blue-yellow conversion.

To reduce the overall form factor, the optoelectronic components comprise an emitter size of less than 25 mm² and particular of less than 16 mm² in some instances. The optoelectronic components can comprise a heat sink for attaching the components to a PCB and the like. They may comprise a collimator, a lens, or another suitable optical element on top. It is possible to arrange the optoelectronic components in rows and columns, thus reducing the overall required space on a PCB. Lenses, diffusors, or other optical elements can be placed over such arrangement.

In some instances, as stated above, the lighting arrangement further comprises a housing or a fixture. The housing and/or fixture comprises a PCB board with at least the control circuit, the adjustable current sources and the at least two light strings arranged thereupon. The AC/DC converter is also arranged within the housing or fixture.

Some further aspects concern the flexible adjustment of power and current to the respective light strings and the optoelectronic components thereof. In some instances, the control circuit is configured to adjust the supply current based on the overall power consumption of the lighting arrangement and/or the overall power consumption of the at least two light strings. In particular, the control circuit may evaluate the overall power consumed by the respective light strings. It may be configured to “boost” one or more light strings with additional current in response thereto. In some configurations, the control circuit may compare the current power or current consumption with a threshold to adjust the power levels accordingly. In some instances, in which an individual string comprises three optoelectronic components, each with a power consumption in the range up to 10 W as described above, the maximum current to be delivered by a current driver is set to about 900 mA. This is larger than actually needed, but the additional headroom reduces the stress on the driver thus increasing its lifetime.

In this regard, it is possible that the control circuit is configured to adjust the duty cycle for each of the adjustable current sources such that an ON-time in the respective duty cycles do not fully overlap. Such approach will not only result in a more even power consumption, but also reduce the heat generation and result in a more constant heat generation and transfer. In some instances, the overall brightness of the light arrangement may be controlled by the duty cycle, while light colour is adjusted by adjusting respective power or current individually to the light strings.

In some instances, the control circuit of the light arrangement is configured to receive a control signal, in particular a digital control signal and derives a duty cycle for at least one of the at least two adjustable current sources.

Another aspect concerns power control and consumption. To avoid damage to the high-power optoelectronic components in the respective light string, the lighting arrangement may further comprise a sensor device configured to provide a signal to the control circuit, wherein the control circuit is configured to adjust at least one of a duty cycle and the supply current. The sensor can be placed within the housing and may be adapted to sense one or more characteristics of the lighting device. In some aspects, the sensor device is a temperature sensor arranged in close proximity to one of the optoelectronic components. The sensor may be configured to obtain the temperature from one or more components, from one or more light strings, from the AC/DC converter and its components or a combination thereof. Several such sensors may be provided to measure those temperatures individually.

Hence, the signal provided by the temperature sensor, or the temperature sensor is indicative of at least one of a temperature of at least one of the optoelectronic components, a temperature of at least one of the at least two light strings, a temperate at a position adjacent to the optoelectronic components of the at least two light strings, and an ambient temperature, in particular inside the housing.

Other sensors may be exploited as well. For example, the lighting device may comprise one or more sensors for measuring a voltage drop across at least one of the light strings or across at least one of the optoelectronic components in at least one of the light strings.

### SHORT DESCRIPTION OF THE DRAWINGS

Further aspects and embodiments in accordance with the proposed principle will become apparent in relation to the various embodiments and examples described in detail in connection with the accompanying drawings in which

FIG. 1A shows a first embodiment for a light arrangement in accordance with the proposed principle;

FIG. 1B shows an embodiment of an adjustable DC/DC current source in accordance with the proposed principle;

FIGS. 2 illustrates a second embodiment for a light arrangement in accordance with the proposed principle;

FIG. 3 shows some housings to illustrate the different form factors between a conventional lighting arrangement and an arrangement according to the proposed principle;

FIG. 4 illustrates a time amplitude diagram for the adjustable current source in accordance with some aspects of the proposed principle;

FIGS. 5A to 5C show different current and dimming levels to illustrate various modes of operation of the lighting arrangement in accordance with the proposed principle.

### DETAILED DESCRIPTION

The following embodiments and examples disclose various aspects and their combinations according to the proposed principle. The embodiments and examples are not always to scale. Likewise, different elements can be displayed enlarged or reduced in size to emphasize individual aspects. It goes without saying that the individual aspects of the embodiments and examples shown in the figures can be combined with each other without further ado, without this contradicting the principle according to the invention. Some aspects show a regular structure or form. It should be noted that in practice slight differences and deviations from the ideal form may occur without, however, contradicting the inventive idea.

In addition, the individual figures and aspects are not necessarily shown in the correct size, nor do the proportions between individual elements have to be essentially correct. Some aspects are highlighted by showing them enlarged. However, terms such as “above”, “over”, “below”, “under” “larger”, “smaller” and the like are correctly represented with regard to the elements in the figures. So it is possible to deduce such relations between the elements based on the figures.

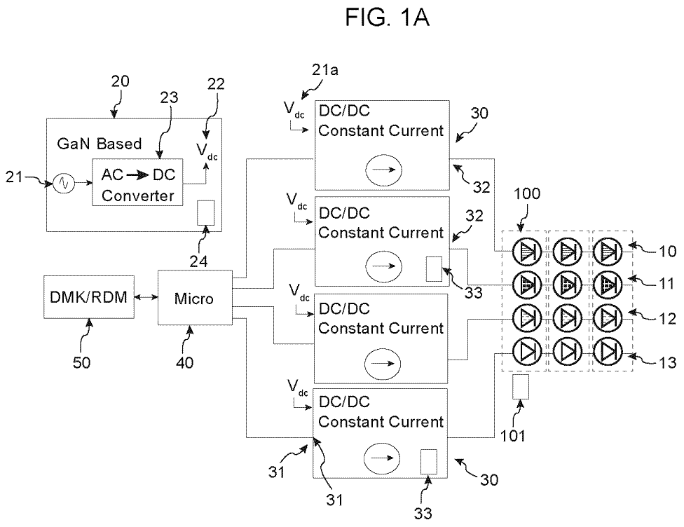

FIG. 1A illustrates a lighting arrangement in accordance with the proposed principle. The lighting arrangement comprises several parts matched to each other in such a way that the shape factor is significantly smaller than the form factor of conventional lighting arrangements. This is achieved by a combination of a power supply 20, adjustable current source 30 as well as several light string portions 100. The lighting arrangement further comprises a microprocessor 40 as well as an interface 50 providing several selection signals for adjustment of brightness, colour temperature and colour.

The lighting arrangement comprises 4 separate strings 10, 11, 12 and 13 with optoelectronic components, each of the component implemented as a high-power LED with an output power of nominal more than 8 W. there are three of such LEDs in each string 10 to 14. Hence, the overall power consumption in each string is more than 24 W and may be in the range of 25 W to 30 W.

Lighting string 10 is configured to emit light of a red colour, lighting, string 11 is configured to emit light of green colour, and lighting string 12 is configured to emit light of blue colour. The last lighting string 13 is implemented with high power LEDs emitting in operation of white light. Said light colour is generated by a respective light conversion, wherein a portion of the emitted light is converted to a different wavelength. The mixing then results in the white coloured emitted light. The respective light strings are implemented as a series circuit, wherein each of the respective LED elements are connected to each other.

The high-power LEDs have an overall size of smaller than 25 mm² and are particularly in the range of 9 mm² to 20 mm². The LEDs are combined in certain positions and arranged on a PCB board to form a circle, triangle, or any other suitable arrangement. It is useful to place a high-power LEDs of each string together, for example to achieve a smooth emission over the entire light surface of the lighting arrangement. Lenses or other optical elements can be arranged over a combination of high-power LEDs to shape the emission characteristics.

The lightings strings also comprise one or more temperature sensors (of one 101 is shown herein) to measure the temperature. The one or more temperature sensors 101 are either placed in close proximity of the high-power LEDs or integrated directly into them. In operation, the one or more sensors 101 determine the operating temperature of the respective optoelectronic components and deliver a corresponding signal to the microcontroller. As the colour does slightly change with temperature, the microcontroller 40 may change the current through the individual lighting strings 10, 11, 12 and 13 accordingly. To prevent damage to the optoelectronic components, the micro controller 40 can also change the ON/OFF ratio of its PWM signal based on the measured temperature, switch off individual components or even the lighting string to reduce the risk of damaging the optoelectronic components.

In addition to the high-power LEDs as optoelectronic components, the lighting arrangement according to the proposed principle also provides high power supply source 20. The power supply source 20 includes an AC/DC converter 23 as its main component, which is configured to receive the main voltage 21 as input. The main voltage is country dependant and can be 110V/AC or 230V/AC. This is the typical household values, but for larger arrangement with even more output power one can also use the 3-phase AC voltage connection.

The AC/DC converter 23 transforms the AC voltage to a DC voltage, that is buffered and finally provided as supply voltage V_{dc} voltage output terminal 22. In some instances, the AC DC converter 23 provides different supply voltages V_{dc}. This will be useful if control circuitry like interface 50, controller 40 and the sensors require different supply voltages (often lower) than the lighting strings, or a high current path (supplying the lighting strings 10, 11, 12, 13) shall be separated from a low current path (supplying the control circuitry).

In order to reduce the form factor of the lighting arrangement, the inventor proposes to utilize a GaN based AC/DC converter 23, in which the switching and high-power transistor components are implemented based on GaN material. Such components have the advantage of a small form factor combined with increased switching and speed high power robustness.

For a given output power, properly designed AC/DC converters 23 using GaN based transistors are realized with significant lower sizes compared to conventional AC/DC converters based on Si technology. The output terminal 22 providing the supply voltage V_{dc} is applied to input terminals of respective adjustable current sources 30. Each of the current sources 30 is controlled by microcontroller 40 both in its output current and the ON/OFF ratio. The first control signal applicable to the respective the DCDC adjustable current source 30 corresponds to the PWM signal defining the ON/OFF ratio to switch the current sources between the ON state and the OFF state, respectively. The second control signal applicable to the adjustable current sources will adjust the overall output current of each current source individually during its ON state. The output terminals 32 are connected to the respective lighting strings.

In addition, two of the adjustable current sources comprise temperature sensors 33 to evaluate the temperature of the current sources in operation. Likewise, the supply voltage portion 20 may also include a respective temperature sensor 24. The temperature sensors provide signals to the microcontroller 44 adjusting the PWM signal or the overall current through the lighting strings, respectively.

In operation, the user can adjust brightness, temperatures colour and colour. This can be done manually or via remote control. In both cases proper selection signals are applied to the DMX/RDN interface 50. The selection signals are converted into a respective PWM signal as well as a supply current for each of the respective current sources connected to the lighting strings 10, 11, 12 and 13.

FIG. 1B illustrates a possible embodiment of an adjustable current sources 30 implemented as DC/DC converter that allows for an adjustment of the current provided by the current source as well as it ON/OFF ratio, refer to as PWM signal. The PWM signal applied to it is a 16 bit digital signal with a refresh rate of about 2 kHz. The current source 30 comprises a power line +V that is directly contacted to the optoelectronic component at its right. The other contact of the LED is coupled to a first capacitor C35 and an inductor coil L6 as well as via a second capacitor CX1 to ground.

The inductor L6 is supplied by the output of a DC/DC buck converter U7 and also connected via fly back diode D5 to the supply line +V. Buck converter U7 is the core of the arrangement and comprises an input for the PWM signal as well as an adjustment input LD for the output current. In operation of this current source 30, if the PVVM signal is set to ON, the buck converter U7 will switch its output connected to the inductor L6 with a high frequency of several 1 kHz. In particular the switching causes a MOSFET within converter U7 to connect its drain terminals D to source terminal CS. The switching causes the inductor L6 to store energy via and release magnetic energy to the capacitor C35, thereby also supplying the optoelectronic components connected thereto with the necessary current. When the PWM signal is set to OFF, the buck DC/DC converter U7 stops suppling the inductor L6. By adjusting the level at the adjustment input LD converter U7 will change the switching frequency of its drain output D, thereby reducing the amount of energy stored at inductor L6.

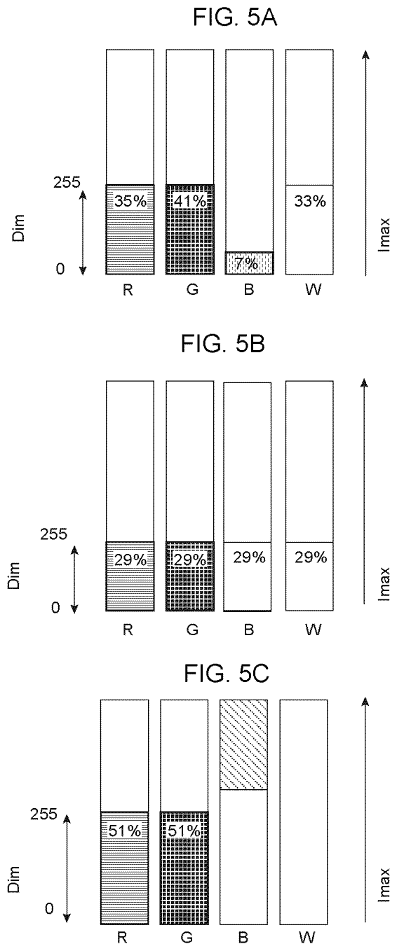

Depending on the mode of operation, see also the explanation of FIGS. 5A to 5C, different current adjustments and thus different overall output currents can be provided. For example, in a so called RGBW equal current mode, in which all strings are supplied by respective adjustable current sources 30, the needed driver current to each LED string is approximately 300 mA when taking into account the rated power of the luminaire.

In order to provide boost modes, in which only one or two strings of different colour are active, the overall output current to be provided by the adjustable current source 30 must be set to a larger value. In the present design example for the source of FIG. 1B, the maximum output current of each current source 30 is set to about 900 mA.

For example, in a so called 1 colour boost mode, in which only one of the four strings are supplied by a respective current, the control circuit can adjust the analogue adjustment input LD such that the converter provides about max. 900 mA current to the LED string connected thereto. In a 2 colour boost mode, (for example corresponding to FIG. 5C), the overall output current for the respective adjustable current sources 30 will be limited by two factors, namely the maximum current 900 mA for each source and the overall rated power (mist be less, to prevent overheating). In an example, the overall maximum current can be set to about 470 mA in 2 colour boost mode due to the limitation of rated power. In RGBW white balance mode, we can give more current to the green string and less current to the blue string to achieve a pleasant white balance colour, see for example FIG. 5A.

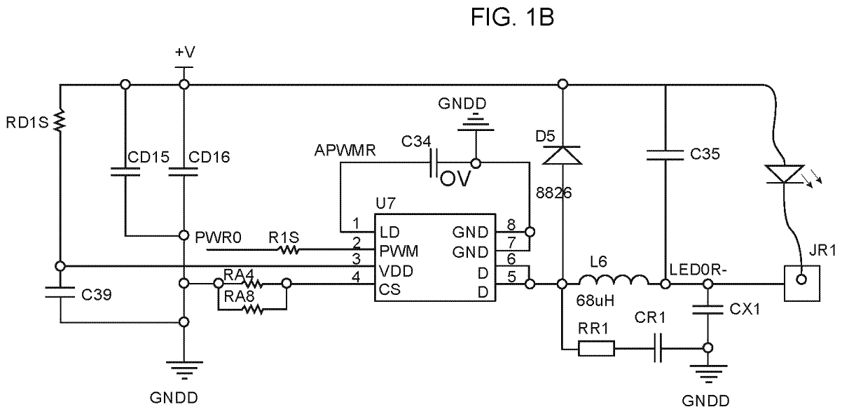

A slightly different example is presented in FIG. 2, in which the various lighting strings 10, 11, 12 and 13 are arranged in series to each other forming and single lighting string 100a. The input terminal of the first portion of lighting string 100a is connected to a single DCDC adjustable current source 30. The current source 30 is supplied by the supply voltage V_{dc} provided by the high output power supply 20 and the AC/DC converter 23, respectively. Like in the previous embodiment, the AC/DC converter 23 is utilizing a GaN based components in particularly field-effect transistors and the like.

The microcontroller 40 comprises an SPI interface which is connected to a matrix manager 60. The matrix manager 60 comprises a plurality of field-effect transistors having a very low drain source resistance R IDS in its respective ON-state. The field-effect transistors are connected with its drain and source terminals between the respective optoelectronic components within the single lighting string 100a as indicated. By switching the field-effect transistors in response to a respective SPI control signal, individual optoelectronic components are bypassed, thus separately and individually switching them into the lighting string or out of it.

It is apparent for the skilled artisan that the SPI interface and the matrix manager 60 can also be used in the embodiment of FIG. 1, for example to switch individual high-power LEDs into the current path or bypass them.

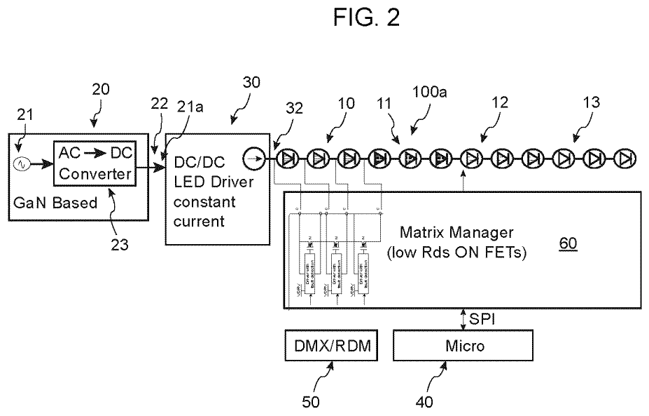

FIG. 3 provides an example illustrating different form factors between the lighting arrangement of the proposed principle and a conventional lighting arrangement. For a given output power, the conventional lighting arrangement 80a comprises a significantly larger surface area below of which a plurality of optoelectronic components is arranged to provide a light emission compared to a lighting arrangement 80 in accordance with the proposed principle. Lighting arrangement 80 fits into housing 81 that is about a quarter of the size of the housing of the conventional lighting arrangement.

This reduction is among other aspects achieved by the utilization of high LED power sources in combination with the GaN based AC/DC converter as a high-power supply. The overall power consumption for operating both lighting arrangements is approximately similar. However, as it can be seen in the conventional lighting arrangement 80, additional vent holes are provided to exchange heat and reduce the temperature within the housing of the conventional arrangement. In contrast, the reduced number of optical components as well as the highly efficient power supply unit produces less heat, which can radiate from the overall reduced surface area of housing 81.

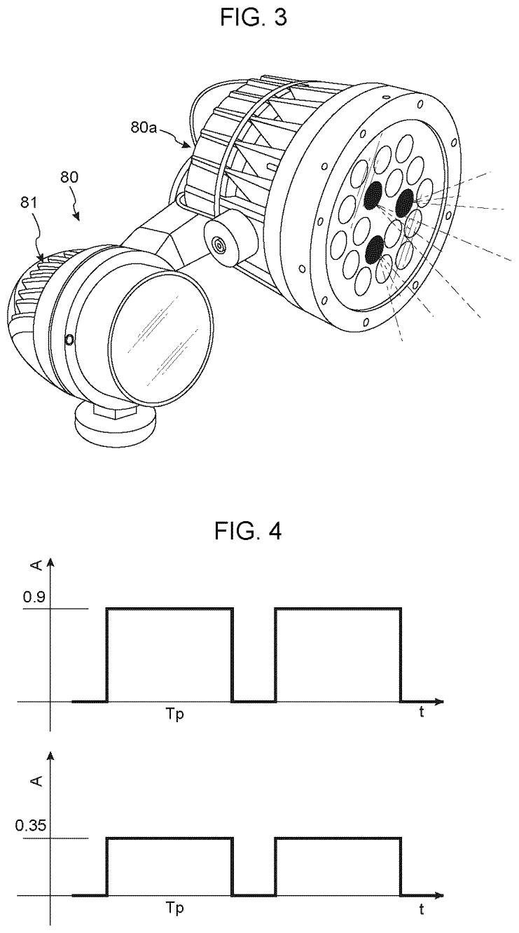

FIG. 4 illustrates another aspect of the proposed principle, which offers a high flexibility, both in terms of brightness adjustment as well as adjusting colour temperature and colour as such. The figure illustrates the ratio for a PWM signal over time. The ON/OFF ratio of a PWM signal defines the time slot over a certain period Tp, in which the current source is in the ON state providing a supply current to the optoelectronic components. The ON/OFF ratio thereby is simply the amount of time over a certain period Tp, in which the optoelectronic components are supplied by a respective supply current.

The longer the optoelectronic components are supplied with current, the brighter the light emission becomes over the overall time period. Consequently, adjusting the ON/OFF ratio and changing the PWM signal, respectively changes the brightness impression of the respective optoelectronic component. The frequency for the PWM signal is in the kilohertz range and will therefore not be visible or recognizable to a user. Rather, increasing the ON time for the optoelectronic components results in a brighter impression of the light emitted from the component, while reducing the ON time will also reduce the brightness impression.

In a conventional lighting arrangement depicted in the upper diagram of FIG. 4, the current through the optoelectronic component during the ON time is close to the maximum of the current source or the respective operating current for the optoelectronic component. This is depicted by the amplitude of the signal in the upper diagram of FIG. 4, which increases from zero during the OFF time to approximately 0.9 for maximum value during the ON time.

In contrast thereto, the lighting arrangement of the proposed principle uses high power LEDs, which can be operated with a significantly smaller current, while still providing the same brightness impression for a given ON/OFF ratio. This is depicted in the lower diagram of FIG. 4, showing the ON/OFF ratio for a high-power optoelectronic component in accordance with the proposed principle. As it can be seen, the overall current is approximately 0.35 of the maximum possible supply current through the optoelectronic component. In other words, the overall current through the high-power optoelectronic component is reduced while providing the same output power and brightness for the predetermined ON/OFF ratio.

This approach provides a further adjustment dimension, in which the current through optoelectronic components and the ON/OFF ratio for the lighting strings can be adjusted individually and separately from each other. Such approach provides the flexibility to change the colour temperature of a given light by mixing additional red or blue light into a white emission. It also offers a booster functionality, in which the brightness of emitted light is significantly increased by enabling a higher current through the device. Finally, one may mix colour or change colours and brightness over time by for example adjusting the current and ON/Off ratio separately.

The AC/DC converter of the proposed principle offers a higher output power at small form factor than conventional converters. For a given output power in the AC/DC converter, one may be able to boost the overall light output over a certain period of time without sacrificing the flexibility and adjustability of the dimming through changing the ON/OFF ratio. FIGS. 5A to 5C illustrate various examples of this separate and individual adjustment of current through the individual lighting strings and the dimming functionality.

FIG. 5A illustrates a default setting with an RGBW lighting string set similar to the embodiment of FIG. 1. The light emission is adjusted to emit while balanced light with a colour temperature of 4000 K, which is in the orange-yellow area.

On the right side, the maximum current Imax through the respective lighting strings is presented. The number within the respective lighting string R, G, B and W corresponds to the percentage of the maximum current Imax through the respective string. Apparently, all strings are supplied well below the maximum current. The above-mentioned colour temperature is achieved by removing a portion of blue, while slightly adjusting the red and green lighting strings R and G. Particularly, string R is set to 35% of its maximum supply current, string G set to 41%, string B set to 7%, and the white light W is set to 33%. The overall emitted light comprises a temperature of about 4000 K.

The left side of the diagram in FIG. 5A illustrates the dimming values from 0 to 255 that is an 8 Bit digital word. Consequently, the brightness for this particular light with the temperature of 4000 K is adjustable in 255 steps completely independent of the colour temperature.

FIG. 5B illustrates the current values for an equal current in each of the respective strings R, G, B, and W. These are set to 29% each resulting in an overall value of 116. This value is the same as in FIG. 5A for the respective strings indicating the possibility to feed different currents to the respective strings to adjust colour and colour temperature, while maintaining the overall current consumption during the ON state of the lighting strings. In other words, for a given maximal current, the respective output power in the individual strings are R, G, B and W can be set individually. Similar to the previous example, the setting also allows for separate adjustment of the brightness by changing the ON/OFF ratio in 256 steps.

Apart from light emission in each of the individual strings, additional colour mixing can be implemented. FIG. 5C illustrates an example in which a mix of red and green again with different dimming settings between 0 and 255 is implemented.

The overall current through both strings resembles a value of 102, which is slightly below the previous value of 116. Hence, for a given overall output power provided by the AC/DC converter, the optoelectronic components can be individually adjusted and supplied with the respective current, while also maintaining the flexibility of an individual dimming for the emitted light.

### LIST OF REFERENCES

10 11, 12, 13 lighting string

20 power supply source

21 net connector

21a input terminal

22 output terminal

23 AC/DC converter

24 temperature sensor

30 adjustable DC/DC current source

31 control terminal

32 output terminals

33 temperature sensor

40 micro controller

50 control interface

101 temperature sensor

What is claimed is:

1. Lighting arrangement, comprising:
at least two light strings, each light string comprising at least one optoelectronic component configured for a power consumption in operation of more than 8 W;
at least two adjustable current sources, each of the adjustable current sources connected to a respective one of the at least two light strings and configured to provide an adjustable supply current to respective one of the at least two light strings;
an AC/DC converter utilizing GaN based FET technology configured to provide a DC supply voltage to the at least two adjustable current sources and the respective light strings connected thereto;
a control circuit coupled to the at least two adjustable current sources and configured to individually adjust a duty cycle for each of the at least two adjustable current sources and the supply current provided by the at least two adjustable current sources.

2. Lighting arrangement according to claim 1, comprising at least four light strings of optoelectronic components, each light string coupled to an adjustable current source, wherein each light string comprises optoelectronic components that are configured to emit light of a certain colour, in particularly red, green, blue and white.

3. Lighting arrangement according to claim 1, wherein the optoelectronic component of the same string is configured to emit light of substantially the same colour and optoelectronic components of two different string are configured to emit light of different colour.

4. Lighting arrangement according to claim 1, wherein at least some of the optoelectronic components comprises an emitter size of less than 25 mm².

5. Lighting arrangement according to claim 1, further comprising a housing of fixture, said housing containing:
a PCB board with at least the control circuit, the adjustable current sources and the at least two light strings arranged thereupon;
the AC/DC converter.

6. Lighting arrangement according to claim 1, wherein the control circuit is configured to adjust the supply current based on the overall power consumption of the lighting arrangement and/or the overall power consumption of the at least two light strings.

7. Lighting arrangement according to claim 1, wherein the control circuit is configured to adjust the duty cycle for each of the adjustable current sources such that an ON-time in the respective duty cycles do not fully overlap.

8. Lighting arrangement according to claim 1, wherein the control circuit is configured to receive a control signal, in particular a digital control signal and derives a duty cycle for at least one of the at least two adjustable current sources.

9. Lighting arrangement according to claim 1, further comprising:
a sensor device configured to provide a signal to the control circuit, wherein the control circuit is configured to adjust at least one of a duty cycle and the supply current;
the signal provided by the sensor device configured indicative of at least one of:
a temperature of at least one of the optoelectronic components;
a temperature of at least one of the at least at least two light strings;
a temperate at a position adjacent to the optoelectronic components of the at least two light strings;
an ambient temperature, in particular inside the housing;
a voltage drop across at least one of the light strings or across at least one of the optoelectronic components in at least one of the light strings.

10. Lighting arrangement according to claim 1, wherein the optoelectronic components of the at least two light strings are arranged in rows and columns on a carrier, in particular a PCB board.
